(19) United States
(12) Patent Application Publication
(10) Pub. No.: US 2024/0155277 A1
(43) Pub. Date: May 9, 2024

(54) PORTABLE COMPUTING DEVICE

(71) Applicant: DOLBY LABORATORIES LICENSING CORPORATION, San Francisco, CA (US)

(72) Inventors: Pengfeng ZHANG, Shanghai (CN); Tiezhong LIU, Shenzhen (CN); Ruozhou HUANG, NanJing (CN); Nengkun LV, Shenzhen (CN); Wenjie GUI, Shenzhen (CN)

(73) Assignee: DOLBY LABORATORIES LICENSING CORPORATION, San Francisco, CA (US)

(21) Appl. No.: 18/281,511

(22) PCT Filed: Mar. 10, 2022
(86) PCT No.: PCT/US2022/019833

§ 371 Date: Sep. 11, 2023

Related U.S. Application Data
(60) Provisional application No. 63/310,713, filed on Feb. 16, 2022.
(60) Provisional application No. 63/177,433, filed on Apr. 21, 2021.

(30) Foreign Application Priority Data
Mar. 12, 2021 (WO) PCT/CN2021/080630

(51) Int. Cl. H04R 1/02; G06F 1/16; G06F 3/16

(52) U.S. Cl. CPC H04R 1/028; G06F 1/1616; G06F 1/1662; G06F 3/16; H04R 2499/15

(57) ABSTRACT

Disclosed is a portable computing device (1) comprising a keyboard (13) and an acoustic transducer (16, 17), the keyboard (13) comprising a key (14, 15), wherein the acoustic transducer (16, 17) is placed in the key (14, 15), and wherein the key (14, 15) comprises a sound port (150) allowing sound generated by the transducer (16, 17) to propagate.

### CROSS-REFERENCE TO RELATED APPLICATIONS

This application claims priority to U.S. Provisional Application Nos. 63/177,433, and 63/310,713, filed Apr. 4, 2021, and Feb. 16, 2022, respectively; and International Application No. PCT/CN2021/080630, filed Mar. 12, 2021, each of which is incorporated by reference in its entirety.

### TECHNICAL FIELD

The present disclosure relates to integrated speakers in a portable computing device.

### BACKGROUND

Many portable computing devices, such as laptop computers comprise loudspeakers for reproducing sound. Typically, the sizing and dimension limits of portable computing devices put certain restrictions on speaker sizing and placement.

### SUMMARY

An object of the present disclosure is to provide an improved acoustic performance of speakers of a portable computing device.

According to a first aspect of the present disclosure, there is provided a portable computing device comprising a keyboard and an acoustic transducer, the keyboard comprising a key, wherein the acoustic transducer is placed in the key, and wherein the key comprises a sound port allowing sound generated by the transducer to propagate.

By providing a sound port in the key, in which the transducer is arranged, sound generated by the transducer may be allowed to propagate, thereby improving the sound to a user. For instance, the influence of the key material, material thickness etc. on sound generated by the transducer, such as a frequency spectrum thereof, may be reduced as at least part of the sound may pass through the sound port.

According to a second aspect of the present disclosure, there is provided a portable computing device comprising an acoustic transducer and a keyboard, the keyboard comprising a key, wherein the acoustic transducer is arranged in or underneath the key, and wherein the portable computing device further comprises a grommet arranged underneath the key, whereby the grommet provides support and vibration reduction for the acoustic transducer and/or the key.

It has been realized that by providing an acoustic transducer in or underneath a key of the keyboard according to the first and/or second aspect, the limited space for acoustic transducers in portable computing device may be utilized to provide an improved sound to the user by allowing for a larger flexibility in sizing and placement of the acoustic transducers. This may, in turn, allow for an improved audio performance of such transducers or loudspeakers given the sizing and dimension limits. The audio performance may be improved in the low and/or high frequency range. By providing the transducer in the key and/or by providing a grommet supporting the transducer and/or key, a damping of a vibration force between a key and the transducer may be provided, which vibration force could reduce the sound quality from the transducer. As an example, where the transducer is provided under the key, a grommet is provided, which may dampen the transmission of a vibration force between the key and the transducer caused by a user striking the key. As another example, where the transducer is provided in the key, the transducer will follow the key movement when a user strikes this. Thereby, a vibration force between the key and transducer, which force could reduce the sound quality from the transducer, may be reduced. Where the transducer is arranged in the key and a grommet is furthermore provided, the vibration force may potentially be further dampened.

By the term “acoustic transducer” may here be understood a transducer configured to emit a sound. The transducer may, for instance, be of a moving coil type, a ceramic type, or a similar transducer type. The transducer may be configured to be a tweeter speaker or may be configured to be a full range speaker.

By “underneath” may herein be understood below, e.g. a key, when the portable computing device is in a use condition. For instance, where an element is arranged “underneath” a key, it may be understood that this will be on the opposite side of a key, such as a top or contact surface of the key, than the finger of a user when the user presses the key.

By a “sound port” may herein be understood one or more opening, such as an opening in the key, i.e. in a material of the key. The sound port may for instance comprise one or more recesses, grooves, or slots. The sound port may be arranged on a portion of the key, which, in a use condition of the portable computing device, faces a user.

Throughout the present disclosure, the term “acoustic transducer” and “transducer” may be used interchangeably.

The portable computing device according to the first aspect may further comprise a grommet underneath the key, the grommet providing support and vibration reduction for the key and/or the transducer.

In some embodiments of the portable computing device according to the first aspect, the key is a first key, and the keyboard further comprises a second key. The acoustic transducer may be a first acoustic transducer, and the portable computing device may further comprise a second transducer. The first transducer may be arranged in the first key and the second transducer may be arranged in the second key. The second key may comprise a sound port allowing sound generated by the second transducer to propagate. The first key may be located on a left portion of the keyboard and the second key may be located on a right portion of the keyboard. Alternatively or additionally each of the first key and the second key may have a size that is larger than an average size of keys on the keyboard.

In some embodiments of the portable computing device according to the first aspect, the key comprises a top surface arranged to face towards a user of the portable computing device in an operational condition of the portable computing device, and wherein the sound port comprises one or more openings in the top surface of the key. Where the portable computing device comprises a first and second acoustic transducer and the keyboard comprises a first key and a second key, each of the first and second keys may comprise a sound port and a top surface arranged to face towards a user of the portable computing device in an operational condition of the portable computing device. The sound port of each of the first and second keys may comprise one or openings in the top surfaces of the first and second key, respectively.

In some embodiments of the portable computing device according to the first aspect, the key comprises a cavity. The acoustic transducer may be arranged in the cavity. Where the portable computing device comprises a first and second acoustic transducer and the keyboard comprises a first key and a second key, each of the first and second keys may comprise a cavity. The first and second acoustic transducers may be arranged in the cavities of the first and second keys, respectively.

Where the keyboard comprises a first key and a second key and the portable computing device comprises a first acoustic transducer and a second acoustic transducer, the first key may comprise a first cavity, in which the first acoustic transducer may being arranged. The second key may comprise a second cavity, and the second acoustic transducer may be arranged inside the second cavity.

Additionally or alternatively, each key of the at least one key may be provided in one piece and/or may be formed integrally, such as manufactured in one piece. Where the at least one key comprises a top surface, the cavity may be arranged underneath the top surface, potentially so that the top surface of the key delimits the cavity.

The key and/or the first and second key may comprise a top surface arranged to face towards the user in an operational condition of the portable computing device. Alternatively or additionally, a key cavity may be provided in one piece or formed integrally with the top surface.

In some embodiments of the portable computing device according to the second aspect, the key is a first key, and the keyboard further comprises a second key. The acoustic transducer may be a first acoustic transducer, and the portable computing device may further comprise a second transducer. The first transducer may be arranged underneath or in the first key and the second transducer may be arranged underneath or in the second key. The grommet may be a first grommet and the portable computing device may comprise a second grommet arranged underneath the second key, whereby the second grommet provides support and vibration reduction for the second acoustic transducer and/or the second key. The first key may be located on a left portion of the keyboard and the second key may be located on a right portion of the keyboard. Alternatively or additionally each of the first key and the second key may have a size that is larger than an average size of keys on the keyboard.

In some embodiments of the portable computing device according to the second aspect, the key further comprises a sound port allowing sound generated by the transducer to propagate. Where the portable computing device comprises a first and second acoustic transducer and the keyboard comprises a first and second key, each of the first and second key may comprise a sound port allowing sound generated by the first and second transducer, respectively, to propagate.

In some embodiments of the portable computing device according to the second aspect the acoustic transducer is arranged in a cavity underneath the key. Where the portable computing device comprises a first and second acoustic transducer and the keyboard comprises a first and second key, each of the first and second acoustic transducers may be arranged in a respective cavity underneath the first and second keys, respectively.

In some embodiments of the portable computing device according to the second aspect, the key is a first key, and the keyboard further comprises a second key. The acoustic transducer may be a first acoustic transducer, and the portable computing device further comprises a second transducer. The first transducer may be arranged underneath the first key and the second transducer may be arranged underneath the second key. The first key may be located on a left portion of the keyboard, and the second key may be located on a right portion of the keyboard. Alternatively or additionally, each of the first key and the second key may have a size that is larger than an average size of keys on the keyboard.

A third aspect of the present disclosure relates to portable computing device comprising a one or more loudspeakers, wherein the one or more loudspeakers is/are configured to retract into the portable computing device in a first position, and to rise above a surface of the portable computing device in a second position so that the one or more loudspeakers face a user of the portable computing device.

By the loudspeakers being configured to retract into a portable computing device in a first position and to rise above the surface to face the user, an improved sound may be provided to the user while keeping the space requirements of a portable computing device. For instance, the speakers may in the second position be arranged to face and provide sound to the user so that an improved sound stage (for instance an improved spatial perception and/or an improved stereo stage).

The one or more loudspeakers may each comprise and/or may each be an acoustic transducer. In some embodiments, the one or more loudspeakers of the portable computing device according to the third aspect is/are one or more acoustic transducers.

The one or more loudspeakers may be and/or may comprise one or more loudspeakers configured to retract into a position behind a display of the portable computing device.

Alternatively or additionally, the portable computing device according to the third aspect further comprises a keyboard and a display. The one or more loudspeakers may be and/or may comprise one or more loudspeakers of a convertible soundbar located between the display and the keyboard.

In some embodiments, the portable computing device may comprise an acoustic transducer and a keyboard comprising a key, wherein the acoustic transducer is placed in the key, and wherein the key comprises a sound port allowing sound generated by the transducer to propagate. Alternatively, the portable computing device may further comprise an acoustic transducer and a keyboard, the keyboard comprising a key, wherein the acoustic transducer is arranged in or underneath the key, and wherein the portable computing device further comprises a grommet arranged underneath the key, whereby the grommet provides support and vibration reduction for the acoustic transducer and/or the key. The acoustic transducer(s) and/or the key(s) as well as any sound port(s) and/or grommet(s) may be as described with respect to the first and second aspects of the present disclosure.

In some embodiments, the portable computing device according to the third aspect further comprises a first and a second transducer and a keyboard, the keyboard comprising a first key and a second key, wherein the first transducer is arranged in the first key and the second transducer is arranged in the second key. The first key may be located on a left portion of the keyboard, and the second key may be located on a right portion of the keyboard. The first and second key may each comprise one or more sound ports allowing sound generated by the first and second transducers to propagate. The portable computing device may further comprise a respective grommet arranged underneath the first key and the second key, each grommet providing support and vibration reduction for a key and/or a transducer.

A fourth aspect of the present disclosure relates to a method of improving performance of speakers in a portable computing device, the method comprising: placing an acoustic transducer in a key of a keyboard of the portable computing device, wherein the at least one key comprises a sound port allowing sound generated by the transducer to propagate.

A fifth aspect of the present disclosure relates to a method of improving performance of speakers in a portable computing device, the method comprising: placing at an acoustic transducer in or underneath a key of a keyboard of the portable computing device, and placing a grommet underneath the key to support the acoustic transducer.

In some embodiments, the placing of the at least one acoustic transducer comprises: placing one or more first transducers in a first key of the at least one key of the keyboard of the portable computing device; placing one or more second transducers in a second key of the at least one key of the keyboard of the portable computing device, wherein the placing a grommet comprises: placing one or more grommets underneath each of the first key and second key to support the first transducer and second transducer, respectively, wherein the first key is located on a left portion of the keyboard, and the second key is located on a right portion of the keyboard, and wherein each of the first key and the second key has a size that is larger than an average size of keys on the keyboard.

### BRIEF DESCRIPTION OF THE DRAWINGS

Embodiments of the present invention will be described in more detail with reference to the appended drawings.

FIG. 1A shows a perspective view of an embodiment of a portable computing device according to the present disclosure,

FIG. 1B shows a perspective cross-sectional view of the embodiment of the portable computing device shown in FIG. 1A according to the present disclosure,

FIG. 2A shows a perspective view of an embodiment of a portable computing device according to the present disclosure,

FIG. 2B shows a perspective cross-sectional view of the embodiment of the portable computing device shown in FIG. 2A according to the present disclosure,

FIG. 2C shows a perspective view of a transducer module comprising a transducer and a grommet of the embodiment of the portable computing device shown in FIG. 2A according to the present disclosure

FIG. 3A shows a perspective view of an embodiment of a portable computing device according to the present disclosure,

FIG. 3B shows a perspective cross-sectional view of the embodiment of the portable computing device shown in FIG. 3A according to the present disclosure,

FIG. 4A shows a perspective view of a transducer module comprising a transducer and a grommet of an embodiment of a portable computing device according to the present disclosure,

FIG. 4B shows a perspective view of a grommet of an embodiment of a portable computing device according to the present disclosure.

FIG. 5 shows a perspective view of an embodiment of a portable computing device according to the present disclosure,

FIG. 6 shows a perspective view of an embodiment of a portable computing device according to the present disclosure,

FIG. 7A shows a perspective view of an embodiment of a portable computing device according to the present disclosure,

FIG. 7B shows a perspective view of a section of the perspective view of the portable computing device shown in FIG. 7A,

FIG. 8A shows a perspective view of a part of a portable computing device according to the present disclosure,

FIG. 8B shows a perspective view of a section of the perspective view of the portable computing device shown in FIG. 8A,

FIG. 8C shows another perspective view of a part of a portable computing device according to the present disclosure.

### DETAILED DESCRIPTION

Throughout the description, similar reference numerals are used for similar elements across the various embodiments and figures described herein.

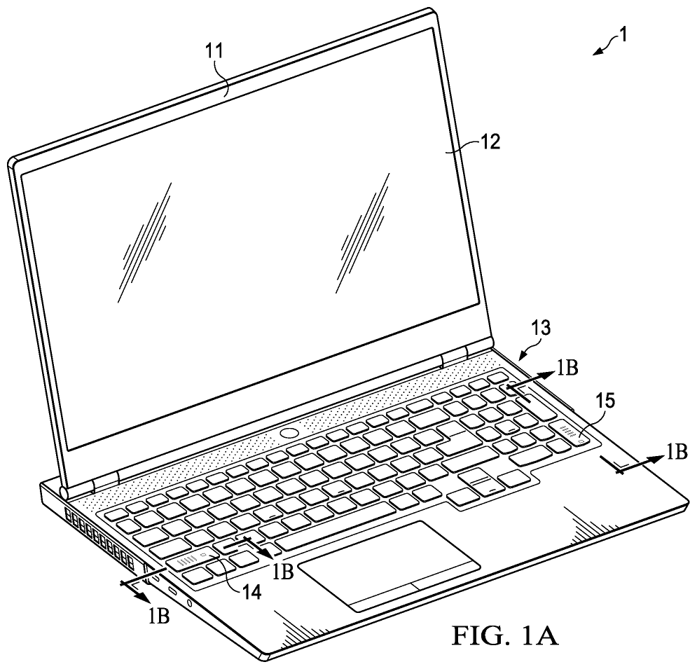

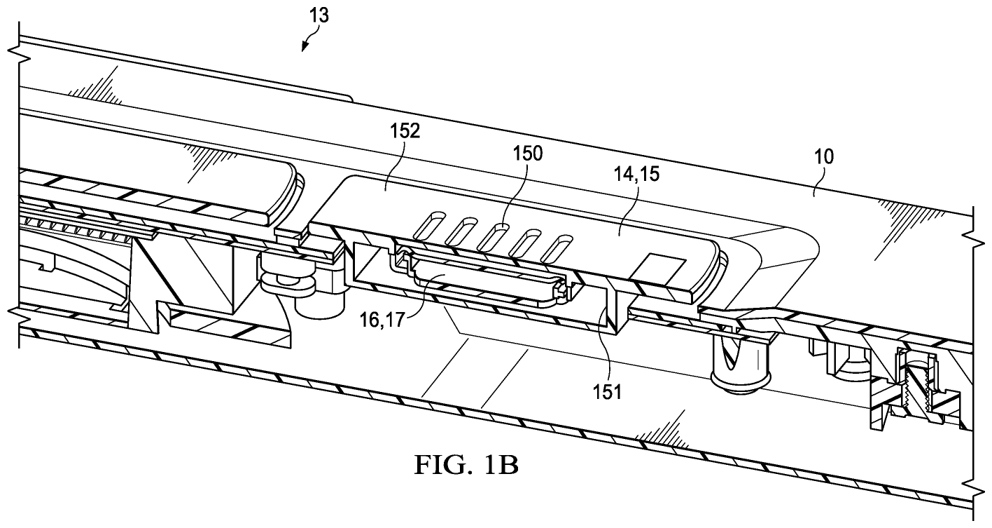

FIG. 1A shows a perspective view of an embodiment of a portable computing device 1 according to the present disclosure. In FIG. 1A, the portable computing device 1 is a portable computer, i.e. a laptop computer. It will, however, be appreciated that the portable computing device in other embodiments may be a different type of portable computing device.

FIG. 1B shows a perspective cross-sectional view of the embodiment of the portable computing device 1 shown in FIG. 1A according to the present disclosure.

The portable computing device 1 illustrated in FIG. 1A comprises a display unit comprising a display housing 11 and a display 12. The display unit is hingedly attached to a chassis 10 of the portable computing device 1. The portable computing device 1 further comprises a keyboard 13. In the view of FIG. 1A, the portable computing device 1 is illustrated in a use condition, i.e. in a condition in which the portable computing device can be used by a user, who can see the display and access the keyboard 13.

The chassis 10 may contain a cavity in which various other parts of the computing device 1, such as one or more processing units, one or more hard drives, solid state disks, a battery and/or the like, may be arranged. A part of the keyboard 13, such as a part of each key may furthermore be provided in the cavity of the chassis, potentially so that a top surface of the key is flush with a surface of the chassis 10 or is raised from a surface of the chassis 10.

The keyboard 13 comprises a first key 14 and a second key 15. The keyboard further comprises a plurality of keys as shown in FIG. 1A. The keyboard 13 is a QWERTY type keyboard but may in other embodiments be a different alphabetic keyboard, a keyboard corresponding to national or linguistical standards, such as a QWERTZ keyboard, an AZERTY keyboard, a Chinese or Japanese full size keyboard, or another type of keyboard, such as a numeric keyboard, a keypad, or the like.

In some embodiments, the keys of the keyboard may be arranged to and/or be configured to be pressed by a user.

The first key 14 is located on a left portion of the keyboard, i.e. a portion of the keyboard, which to a user in the use condition of the portable computing device is arranged left of a center, such as a geometrical center, of the keyboard 13. Correspondingly, the second key 15 is located on a right portion of the keyboard 13, i.e. a portion of the keyboard 13, which to a user in the use condition of the portable computing device is arranged right of a center, such as a geometrical center, of the keyboard. In other embodiments, the first 14 and second key 15 may be arranged at opposite sides of the keyboard 13 and/or may be two, respective, outermost keys of the keyboard 13.

The first 14 and second key 15 each comprise a sound port 150 as shown in FIGS. 1A and 1B. The sound port is arranged in a top surface 152 of the keys 14, 15. The sound port 150 comprises a plurality of openings in the top surface 152 of the respective keys 14, 15. As seen in FIG. 1B, the sound port consists of 5 elongate openings in the top surface 152. The top surface 152 is the surface of the key 14, 15, which is configured to be in contact with a finger of the user, when the user presses the key 14, 15. In other embodiments, the sound port may be or comprise one or more grooves, openings of other shapes, recesses, or the like in the top surface 152 and or in another surface of the key 14, 15.

The portable computing device 1 further comprises a first transducer 17 and a second transducer 16. As can be seen in FIG. 1B, the first 17 and second transducers 16 are arranged in the first 14 and second keys 15, respectively. In this embodiment, the transducers 16, 17 are arranged in a respective cavity 151 of the keys 14, 15. The first 14 and second key 15 may be formed integrally and/or made in one piece. Alternatively or additionally, an enclosure surrounding the cavity 151 may be made in one piece and/or formed integrally, potentially in one piece and/or formed integrally with the top surface 152.

As can be seen in FIG. 1A, the first 14 and second keys 15 are both keys, which are larger than an average size of the keys of the keyboard. In the keyboard 13 shown in FIG. 1A, the first 14 and second keys 15 may correspond to a left “Shift” button and an “Enter” button of a numeric section of the keyboard 13, respectively.

In this and other embodiments, the first transducer and second transducer 16 may be arranged to be and/or constitute a left and right speaker, respectively. Alternatively or additionally, the first 17 and second transducer 16 may be tweeters and/or may be full-range transducers. Each of the first 17 and second transducer 16 may in all embodiments be any type of transducer, such as an electrodynamic transducer, a ceramic transducer, a piezoelectric transducer, or the like.

In some embodiments, the computing device 1 may comprise a grommet arranged underneath the keyboard, e.g. under a key, whereby a key, such as the first 14 and/or second 15 key, or a transducer, such as the first 17 or second 16 transducer, is supported, and/or wherein vibration is dampened, potentially between the key and the transducer. The computing device 1 may comprise a respective grommet arranged underneath each of the first 14 and second keys 15. The grommet(s) may alternatively or additionally be arranged to dampen a vibration force from the first key 14 to the first transducer 17 or vice versa, or from the second key 15 to the second transducer 16 or vice versa.

Any grommet(s) may be made from a resilient material and/or may be arranged to form a suspension for a key and/or a transducer.

Each of the first 14 and second keys 15 and any other key of the keyboard 13 may comprise a respective key module, potentially supporting the key, in which the respective keys may be arranged.

In other words, FIGS. 1A-1B, show an example portable computing device where the transducers are integrated with specified keys and use those keys as a chamber, so the whole assembly would be both a key for keyboard and speakers for laptop. The keys with transducers are opened on the top for sound transmitting. The transducers can be moving coil type, ceramic type or others which can be installed inside. Normally the tweeter speakers can be designed in this way, sometimes the full range.

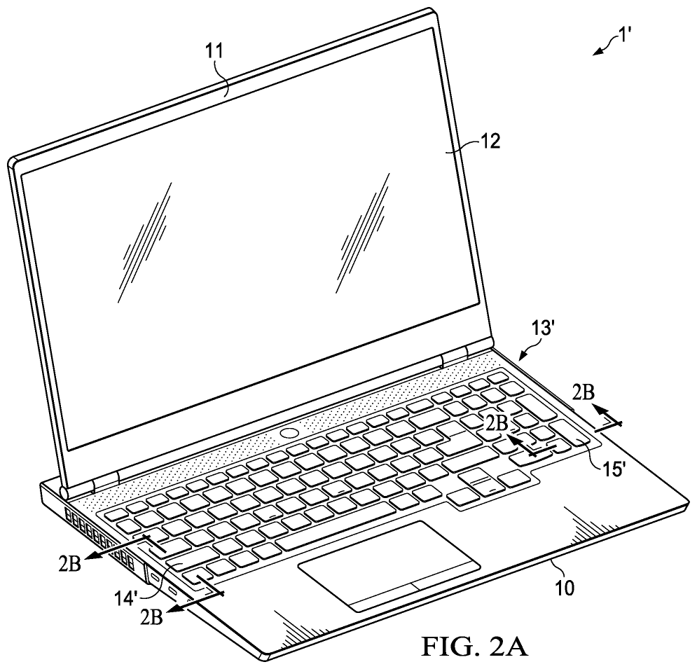

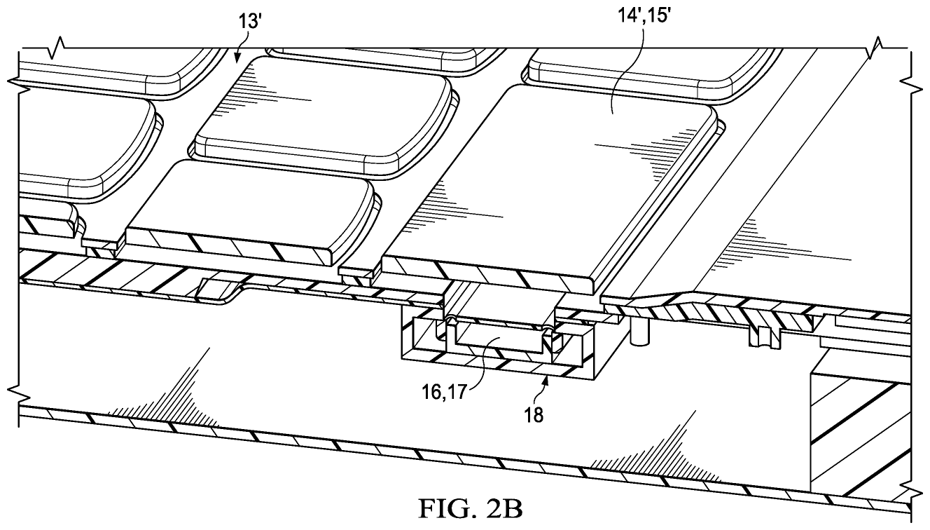

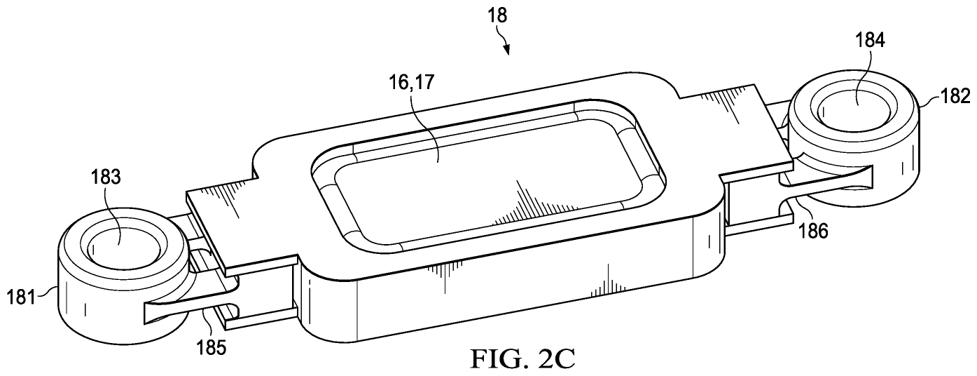

FIG. 2A shows a perspective view of an embodiment of a portable computing device 1′ according to the present disclosure. FIG. 2B shows a perspective cross-sectional view of the embodiment of the portable computing device 1′ shown in FIG. 2A according to the present disclosure,

The computing device 1′ comprises a display unit comprising display housing 11, a display 12, and a chassis 10. The chassis 10 and the display unit may be as described with respect to the computing device shown in FIGS. 1A and 1B. The computing device 1′ further comprises a first transducer 17 and a second transducer 16.

The computing device 1′ further comprises a keyboard 13′ comprising a first 14′ and a second key 15′. The first key 14′ and the second key 15′ do, in the illustrated embodiment, not comprise a sound port, nor a cavity. In other embodiments, the first key 14′ and the second key 15′ may each comprise a sound port and/or a cavity.

Other features of the first 14′ and second keys 15′ may be similar or identical to the features the first 14 and second keys 15 as described with respect to FIGS. 1A and 1B.

The computing device 1′ further comprises a first 17 and second 16 acoustic transducer arranged underneath the first 14′ and second key 15′, respectively, and a respective grommet arranged underneath the first 14′ and second key 15′, whereby the grommet provides support and vibration reduction for the first and second acoustic transducer 17, and/or the key 14′, 15′. In other embodiments, the first and second acoustic transducers may be arranged in the key.

FIG. 2C shows a perspective view of a transducer module 18 comprising the first or second transducer 16, 17 and two grommets 181, 182 of the embodiment of the portable computing device 1′ shown in FIG. 2A according to the present disclosure. FIG. 2C specifically shows the key 14′, 15′ and the transducer 16, 17. The transducer 16, 17 is part of a transducer module comprising the transducer 16, 17 and two grommets 181, 182.

From FIG. 2B, it is seen that the transducer module 18 with the transducer 16, 17 is arranged underneath the first key 14′ and underneath the second key 15′.

The two grommets 181, 182 act as a suspension and supports the transducer 16, 17. In another embodiment, the two grommets 181, 182 may additionally or alternatively support the key 14′, 15′. Each of the two grommets 181, 182 further provides vibration damping, i.e. each reduces a vibration force from the key 14′, 15′ to the transducer 16, 17, and vice versa. A such vibration from the key may, for instance, occur when a user presses down the key 14′, 15′.

The grommets 181, 182 are made from a resilient material.

As seen in FIG. 2C, the grommets 181, 182 are both substantially cylindrical in shape. The grommets 181, 182, each comprise a respective opening 183, 184, and a respective flange portion 185, 186, which engages with the transducer 16, 17. The openings 183, 184 may be for receiving a fastening device, such as a screw, bolt, or the like, to fixate and/or fasten the transducer 16, 17 and/or a key, such as key 13, 14, 13′ or 14′. In other embodiments, the grommets 181, 182, may be of other shapes.

The portable computing device 1′ may comprise two transducer module 18, each comprising a respective one of the first 16 and second transducers 17 and one or more grommets 181, 182.

The first 17 and second transducer 16 are arranged underneath the respective first 14′ and second keys 15′. In this embodiment, the first 17 and second transducer 16 are both arranged in a cavity of the chassis 10 of the portable computing device 1′ as e.g. shown in FIG. 2B. Correspondingly, the grommets 181, 182 of the transducer module 18 are arranged underneath the key.

The first 17 and second transducers 16 may be similar or identical to the first 17 and second 16 transducers as described with respect to FIGS. 1A and 1B.

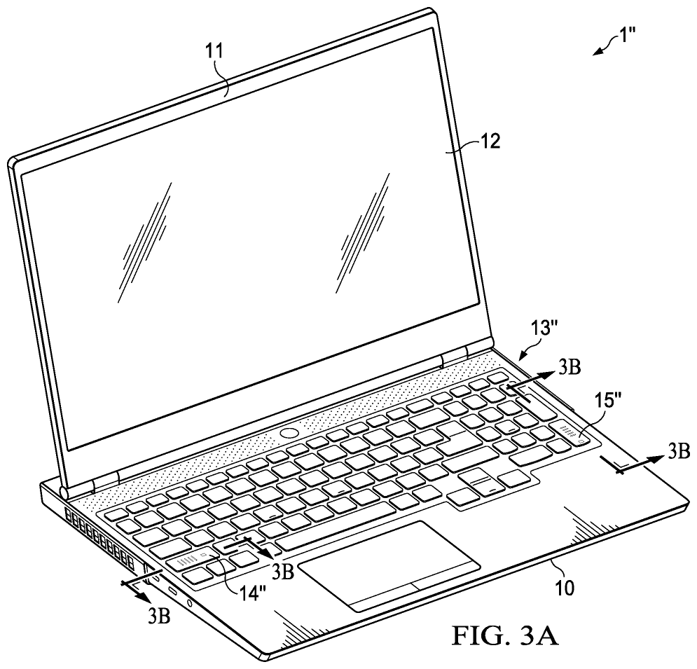

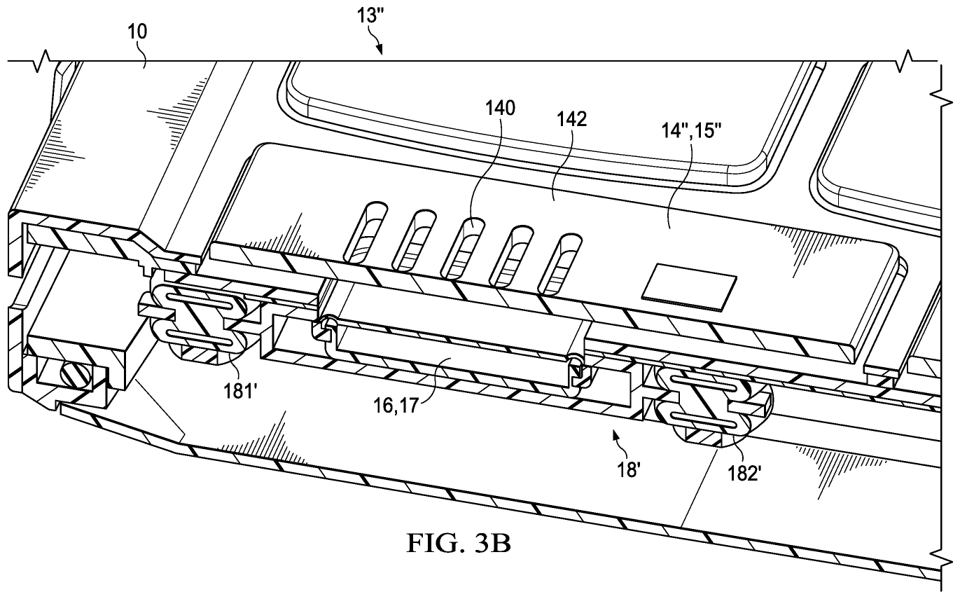

FIG. 3A shows a perspective view of an embodiment of a portable computing device 1″ according to the present disclosure,

FIG. 3B shows a perspective cross-sectional view of the embodiment of the portable computing device 1″ shown in FIG. 3A according to the present disclosure. The computing device 1″ comprises a display unit comprising display housing 11, a display 12, and a chassis 10. The chassis 10 and the display unit may be as described with respect to the computing device shown in FIGS. 1A and 1B and/or FIGS. 2A and 2B. The computing device 1″ further comprises a first transducer 17 and a second transducer 16.

The computing device 1″ further comprises a keyboard 13″ comprising a first 14″ and a second key 15″. The first key 14″ and the second key 15″ do, in the embodiment shown in FIGS. 3A and 3B each comprise a sound port 140. In FIG. 3B, the sound port 140 of the key 14″, 15″ is shown. The sound port 150 may be similar and/or identical to the sound port 150 described with respect to the FIGS. 1A and 1B.

In FIGS. 3A and 3B, the first 14″ and second keys 15″ do not comprise a cavity. In other embodiments, the first key 14″ and the second key 15″ may each comprise a cavity, potentially in which a transducer may be arranged.

Other features of the first 14″ and second keys 15″ may be similar or identical to the features the first 14, 14′ and second keys 15, 15′ as described with respect to FIGS. 1A, 1B, 2A, 2B, and 2C and/or to the like.

As seen in FIGS. 3A and 3B, the first 14″ and second key 15″ each comprise a sound port 140 in a top surface 142 of the first key 14″. The sound port 140 and top surface 142 of the first 14″ and second keys 15″, respectively, may be identical or similar to the sound port 150 and top surface 152 of the key 15 and/or may comprise any feature described in relation to sound port 150 and top surface 152.

The portable computing device 1″ further comprises a transducer module 18′ comprising the transducer 16, 17 and two grommets 181′, 182′. The grommets 181′ and 182′ each support and provide vibration reduction to the first transducer 17.

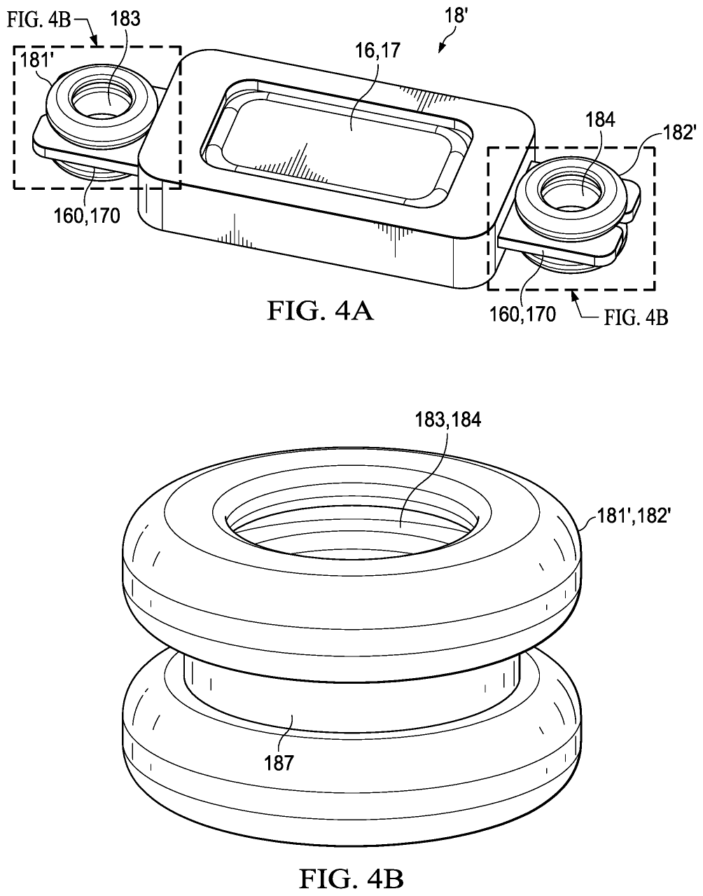

In other embodiments, the transducer module 18′ may comprise fewer, such as one, or more, such as three, four, five, six, seven, eight, or more grommets. The transducer module 18′ is illustrated in FIGS. 4A and 4B and will be described in further detail with reference to these figures. The transducer module 18′ may in other embodiments be identical to transducer module 18. Alternatively or additionally the transducer module 18′ may comprise any feature described with respect to transducer module 18.

The portable computing device 1″ may further comprise a transducer module comprising the second transducer and one or more grommets, potentially providing support to the second transducer and/or the second key 15″.

FIGS. 4A and 4B shows a perspective view of the transducer module 18′ comprising the first transducer 17 and two grommets 181′, 182′. As shown in FIGS. 4A and 4B, the two grommets 181′ and 182′ each comprise a respective groove 187, 188 for engaging with a respective flange portion 160, 170 of the transducer module 18′ and/or a housing of the transducer 16, 17. The grommets 181′, 182′ furthermore comprise a respective opening 183, 184. The openings 183, 184 may be for receiving a fastening device, such as a screw, bolt, or the like, to fixate and/or fasten the transducer 16, 17 and/or a key, such as key 13, 14, 13′ or 14′.

As can be seen in FIGS. 4A and 4B, the groove 187, 188 is a section of the grommet 181′, 182′, at which the diameter of the grommets 181′, 182′ is reduced. The groove 187, 188 may alternatively be an engagement portion of the grommets 181′, 182′.

In other embodiments the transducer module 18′ may comprise two grommets without the grooves, such as grommets 181 and 182 of transducer module 18. The grommets may, like grommets 181 and 182, comprise a protrusion for engaging with a portion of the transducer and/or a transducer housing. Transducer module 18′ and grommets 181′ and 182′ may each comprise any feature described herein with respect to transducer module 18 and grommets 181 and 182. Correspondingly, transducer module 18 and grommets 181 and 182 may each comprise any feature described herein with respect to transducer module 18′ and grommets 181′ and 182′.

For illustrative purposes, transducer modules 18 and 18′ are illustrated comprising the transducer 16, 17. It will, however, be appreciated that each of transducer module 18 and 18′ may comprise any one of the first 17 and the second transducer 16.

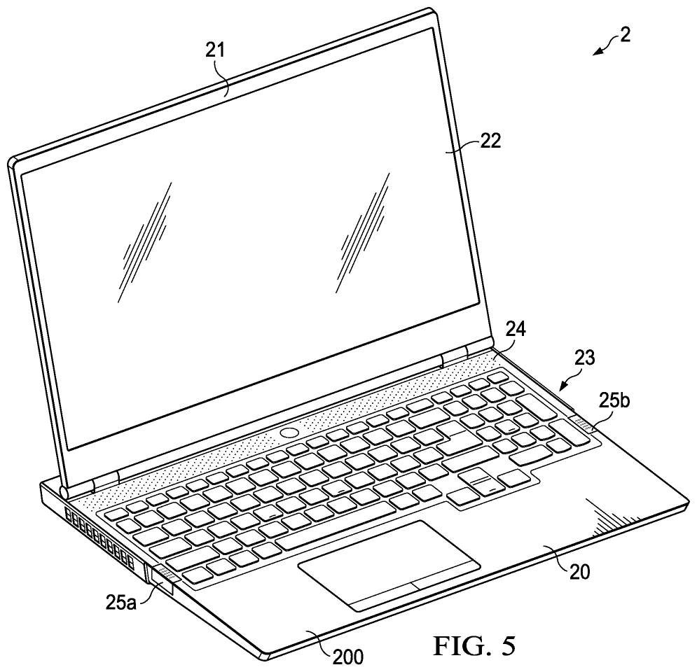

FIG. 5 shows a perspective view of an embodiment of a portable computing device 2 according to the present disclosure.

The portable computing device 2 portable comprises one or more loudspeakers 24, wherein the one or more loudspeakers is/are configured to retract into the portable computing device 2 in a first position, and to rise above a surface of the portable computing device 2 in a second position so that the one or more loudspeakers 24 face a user of the portable computing device 2.

The computing device 2 comprises a display unit comprising display housing 21, a display 22, and a chassis 20. The chassis 20 and the display unit may be as described with respect to the chassis 10 and the display unit comprising the housing 11 and the display 12 of any of the computing devices 1, 1′, and 1″. The computing device further comprises a keyboard 23. The keyboard may be similar with, identical to, and/or comprise any feature described in relates to any of the keyboards 13, 13′, or 13″ of any of the computing devices 1, 1′, and 1″.

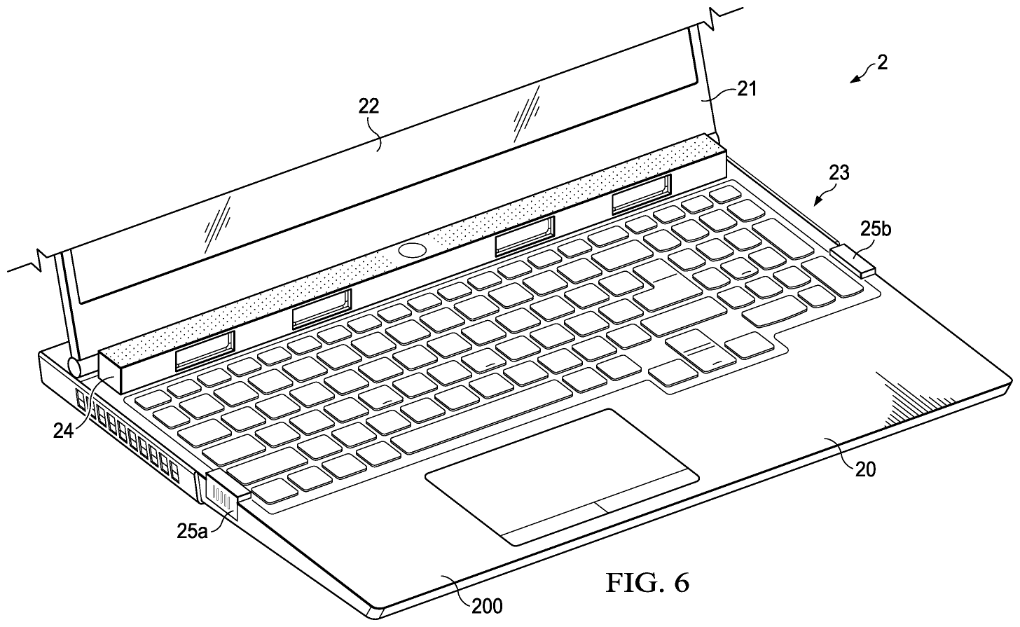

The computing device 2 is in FIG. 5 illustrated in a use condition. In FIG. 5, the computing device is illustrated with the one or more loudspeakers 24 in the first position. FIG. 6 shows a perspective view of an embodiment of a portable computing device 2 according to the present disclosure. In FIG. 6, the computing device 2 is illustrated with the one or more loudspeakers 24 being in the second position.

The one or more loudspeakers may be and/or comprise one or more transducers. The transducer may be any transducer, e.g. as described with respect to the transducers 16 and 17. Alternatively or additionally, the one or more loudspeakers may comprise one or more transducers and one or more enclosures, potentially each enclosing a volume.

The chassis 20 further comprises a surface 200, which, in the use condition of the computing device 2 faces a user thereof. The surface 200 is a top surface. In some embodiments, the surface 200 may lie a first plane, and the loudspeaker(s) 24 may be configured to, in the first position, be on a first side, such as be completely on the first side, of the plane and, in the second position, be at least partly on a second side of the plane.

The chassis 20 may comprise a cavity. The one or more loudspeakers 24 may be configured to be movable between a first position, in which the one or more loudspeakers 24 is/are located, such as enclosed, in a cavity of the chassis 20 and a second position, in which at least a portion of the one or more loudspeakers 24 protrudes from the cavity of the chassis 20.

The one or more loudspeakers 24 may in the first position be arranged in a cavity of the chassis. The cavity of the chassis 20 may be arranged in between a top surface 200 of the chassis and a bottom surface of the chassis 20. The top surface may be arranged to face towards a user in a use condition of the portable computing device. Alternatively or additionally, the top surface 200 may be configured to receive a keyboard and/or comprise a keyboard. In some embodiments, the top surface comprises openings for receiving a keyboard and/or keys of a keyboard.

In the second position, at least a portion of the plurality of loudspeakers may be arranged at a level above the top surface, potentially when seen along a top-down direction extending from a bottom surface to a top surface of the chassis. A top-down direction may be substantially perpendicular to the top surface.

The chassis 20 may comprise an opening, through which the one or more loudspeakers may be moved into or out of the cavity.

In some embodiments, the one or more loudspeakers is completely enclosed in the chassis cavity in the first position. Alternatively or additionally, the one or more loudspeaker is not completely enclosed in the chassis cavity in the second position and/or is partially or not enclosed in the chassis cavity in the second position.

The one or more loudspeakers 24 may be configured to be in the first position may be when the loudspeakers 24 and/or the portable computing device 2 is/are not in use. Alternatively or additionally, the one or more loudspeakers 24 may be configured to be in the second position when the loudspeakers 24 and/or the portable computing device 2 is/are in use. The loudspeakers 24 may be moved by an electric motor and/or a hydraulic or pneumatic system between the first and second position, potentially automatically in response to a determination that the loudspeakers 24 are in use or to be used.

In the embodiment shown in FIGS. 5 and 6, the one or more loudspeakers 24 comprise one or more loudspeakers 24 of a convertible soundbar located between the display 22 and/or the display unit, such as between one or more hinges of the display unit, and the keyboard 23.

The portable computing device 2 further comprises a first side speaker module 25a and a second side speaker module 25b. The first 25a and second side speaker modules 25b are configured to be movable between a first position and a second position. In the first position, the first and second side speaker modules 25a, 25b may face upwards, i.e. in a direction towards a user and potentially orthogonally to a top surface of keys of the keyboard 23 and/or orthogonally to the surface 200. In the second position, the first and second side speaker modules may face laterally, potentially in opposite directions. The second side speaker modules may face in a direction substantially parallel to or parallel to a direction of extend of the surface 200 and/or in a direction substantially parallel to or parallel to direction of extend of a top surface of keys of the keyboard. In FIG. 5, the first 25a and second side speaker modules 25b are illustrated in the first position. In FIG. 6, the first 25a and second side speaker modules 25b are illustrated in the second position.

The first 25a and second side speaker modules 25b may be configured to be in the first position when the one or more loudspeakers 24 are in their first position and in the second position when the one or more loudspeakers 24 are in their second position.

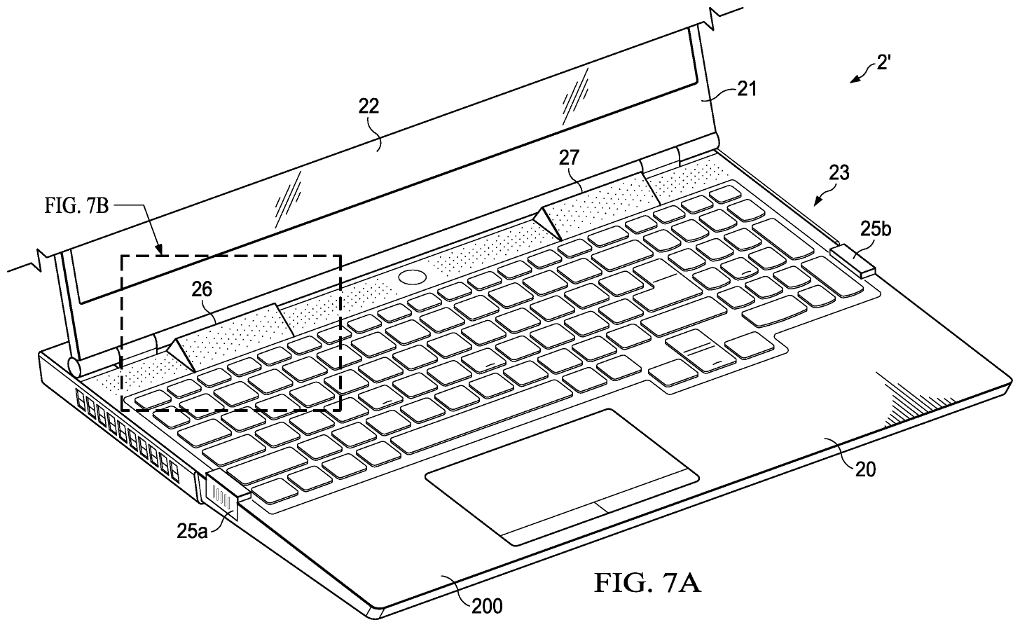

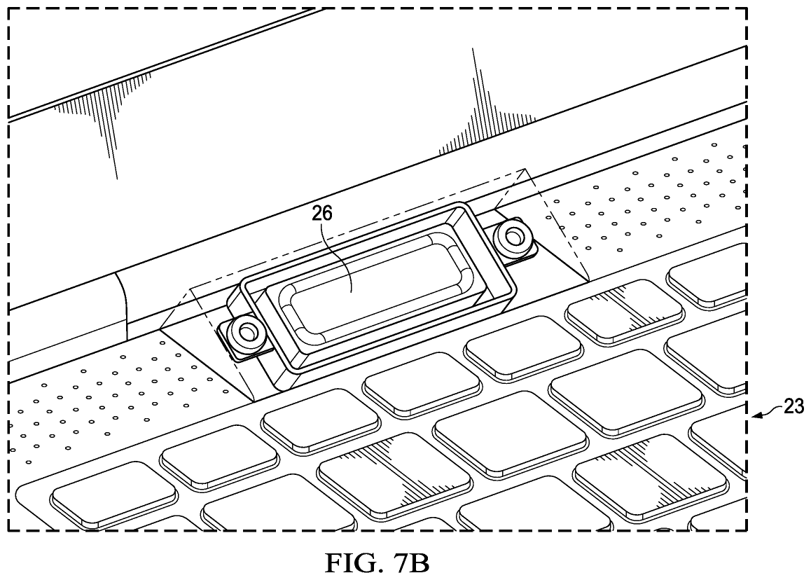

FIG. 7A shows a perspective view of an embodiment of a portable computing device 2′ according to the present disclosure. FIG. 7B shows a perspective view of a section of the perspective view of the portable computing device 2′ shown in FIG. 7A.

Like the portable computing device 2, the portable computing device 2 comprises a display unit comprising a display housing 21 and a display 22, a keyboard 23 and a first 25a and a second side speaker module 25b.

The portable computing device 2′ further comprises a first 26 and second loudspeaker 27. The first and second loudspeaker may be arranged to be a left and right loudspeaker, respectively.

The first 26 and second loudspeakers 27 are configured to retract into the portable computing device in a first position, and to rise above a surface of the portable computing device in a second position so that the first 26 and second loudspeakers 27 face a user of the portable computing device 2′. The first 26 and second loudspeakers 27 are shown to be in the second position in FIGS. 7A and 7B. Correspondingly, the side speaker modules 25a, 25b are shown to be in the second position in FIG. 7A.

The first 26 and second loudspeakers 27 may comprise one or more features as described with respect to the one or more speakers 24 of the portable computing device 2.

In the first position of the loudspeakers 26, 27, the loudspeakers are each arranged and enclosed in a respective cavity of the chassis 20′. The chassis may comprise two cavities for housing and/or completely enclosing the first 26 and second loudspeakers 27, respectively, and/or may otherwise comprise similar or identical features to the chassis 20.

In the first position of the loudspeakers 26, 27, the portable computing device 2′ may look like the portable computing device 2 as illustrated in FIG. 5.

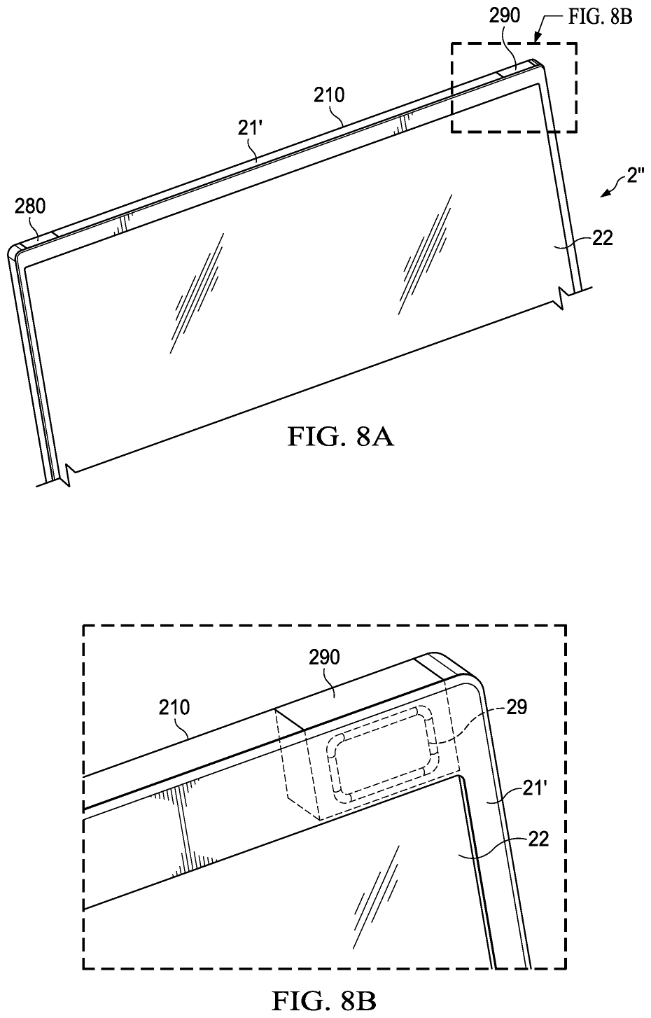

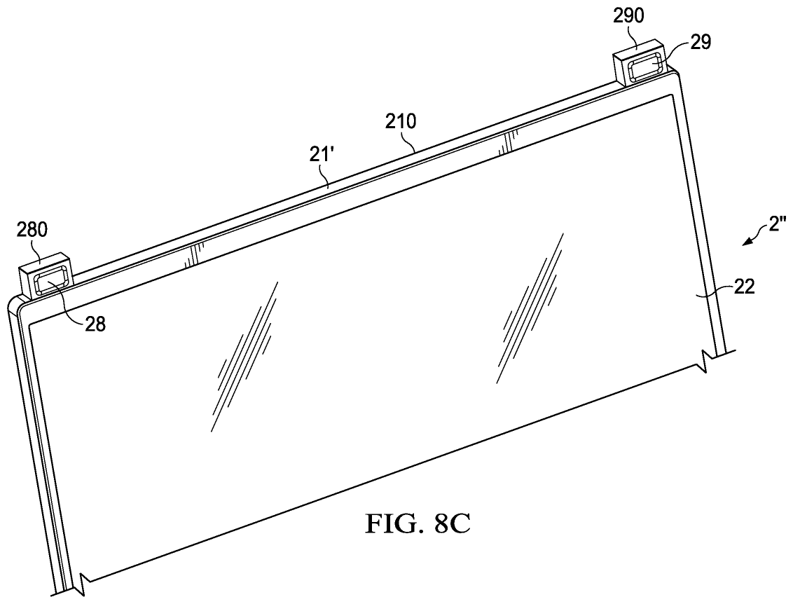

FIG. 8A shows a perspective view of a part of a portable computing device 2″ according to the present disclosure. FIG. 8B shows a perspective view of a section of the perspective view of the portable computing device 2″ shown in FIG. 8A, and FIG. 8C shows another perspective view of a part of a portable computing device 2″ according to the present disclosure.

In FIGS. 8A-8C, a display unit of a portable computing device 2″ comprising a display housing 21 and a display 22 is shown. It will be understood the portable computing device 2″ may further comprise any feature described with respect to portable computing devices 1, 1′, 1″, 2, and 2′, such as a chassis 10, 20, 20′, a keyboard 13, 13′, 13″, 23, a first key 14, 14′, 14″, a second key 14, 14′, 14″, transducers 16, 17, grommets 181, 181′, 182, 182′, one or more speakers 24, 26, 27, and/or side speaker modules 25a, 25b.

The portable computing device 2″, comprises one or more loudspeakers, i.e. in the illustrated embodiment a first 28 and a second top loudspeaker 29, configured to retract into a position behind a display 22 of the portable computing device 2″. In some embodiments, the top loudspeakers 28, 29 are configured to retract between a surface of the display housing 21′. The top loudspeakers 28, 29 are in FIGS. 8A and 8B illustrated in a first position thereof, in which they are located behind a display 22 of the portable computing device. By “behind” may here be meant that the display 22 and/or display housing prevents the user from seeing the loudspeakers 28, 29 and/or the display and/or display housing 21′ is in the acoustic path of sound from the top loudspeakers 28, 29 to the user.

In FIG. 8C, the top loudspeakers 28, 29 are illustrated in a second position, in which they face the user and/or protrude from a surface 210 of the display unit, i.e. from the display housing 21. The top loudspeakers 28, 29 may be any type of transducer as described with respect to the one or more loudspeakers 24. The first 28 and second loudspeakers may alternatively or additionally be configured to be a left and right loudspeaker, respectively.

The top loudspeakers 28, 29 may be configured to be in the first position may be when the top loudspeakers 28, 29 and/or the portable computing device 2″ is/are not in use. Alternatively or additionally, the top loudspeakers 28, 29 may be configured to be in the second position when the top loudspeakers 28, 29 and/or the portable computing device 2″ is/are in use. The top loudspeakers 28, 29 may be moved by an electric motor and/or a hydraulic or pneumatic system between the first and second position, potentially automatically in response to a determination that the loudspeakers 28, 29 are in use or to be used.

The display housing 21′ comprises two cavities for receiving the first 28 and second top loudspeaker 29, respectively, when these are in the first position. The first top loudspeaker 28 comprises a top surface 280, which is configured to be flush with the display housing top surface 210, when the top loudspeakers 28, 29 are in the first position. The second top loudspeaker 29 similarly comprises a top surface 290, which is configured to be flush with the display housing top surface 210, when the top loudspeakers 28, 29 are in the first position.

In some embodiments, where the portable computing device 2″ further comprises additional loudspeakers 24, 26, 27, the top loudspeakers 28, 29 may be configured to be in the first position when the loudspeakers 24 or 26, 27 are in the first position, and to be in the second position when the loudspeakers 24 or 26, 27 are in the second position.

### Final Remarks

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that more features are required than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be encompassed, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described specific embodiments of the invention, those skilled in the art will recognize that other and further modifications may be made, and it is intended to claim all such changes and modifications. For example, any formulas given above are merely representative of procedures that may be used. Functionality may be added or deleted from the block diagrams and operations may be interchanged among functional blocks. Steps may be added or deleted to methods described.

1. A portable computing device comprising a keyboard and an acoustic transducer, the keyboard comprising a key,
wherein the acoustic transducer is placed in the key, and
wherein the key comprises a sound port allowing sound generated by the transducer to propagate.

2. The portable computing device according to claim 1, further comprising a grommet underneath the key, the grommet providing support and vibration reduction for the key and/or the transducer.

3. The portable computing device according to claim 1, wherein the key is a first key, and wherein the keyboard further comprises a second key, wherein the acoustic transducer is a first acoustic transducer, and wherein the portable computing device further comprises a second transducer, the first transducer being arranged in the first key and the second transducer being arranged in the second key, and
wherein the first key is located on a left portion of the keyboard, and the second key is located on a right portion of the keyboard, and
wherein each of the first key and the second key has a size that is larger than an average size of keys on the keyboard.

4. The portable computing device according to claim 1, wherein the key comprises a top surface arranged to face towards a user of the portable computing device in an operational condition of the portable computing device, and wherein the sound port comprises one or more openings in the top surface of the key.

5. The portable computing device according to claim 1, wherein the key comprises a cavity, and wherein the transducer is arranged in the cavity.

6. A portable computing device comprising an acoustic transducer and a keyboard, the keyboard comprising a key,
wherein the acoustic transducer is arranged in or underneath the key, and
wherein the portable computing device further comprises a grommet arranged underneath the key, whereby the grommet provides support and vibration reduction for the acoustic transducer and/or the key.

7. The portable computing device according to claim 6, wherein the key comprises a sound port allowing sound generated by the transducer to propagate.

8. The portable computing device according to claim 6 wherein the acoustic transducer is arranged in a cavity underneath the key.

9.-12. (canceled)

13. A method of improving performance of speakers in a portable computing device, the method comprising:
placing an acoustic transducer in a key of a keyboard of the portable computing device, wherein the at least one key comprises a sound port allowing sound generated by the transducer to propagate.

14. A method of improving performance of speakers in a portable computing device, the method comprising:
placing at least one acoustic transducer in or underneath a key of a keyboard of the portable computing device, and
placing a grommet underneath the key to support the acoustic transducer.

15. The method according to claim 14, wherein the placing of the at least one acoustic transducer comprises:
placing one or more first transducers in a first key of the at least one key of the keyboard of the portable computing device;
placing one or more second transducers in a second key of the at least one key of the keyboard of the portable computing device, and
wherein the placing a grommet comprises:
placing one or more grommets underneath each of the first key and second key to support the first transducer and second transducer, respectively,
wherein the first key is located on a left portion of the keyboard, and the second key is located on a right portion of the keyboard, and
wherein each of the first key and the second key has a size that is larger than an average size of keys on the keyboard.
